(19) United States
(12) Patent Application Publication
(10) Pub. No.: US 2013/0218974 A1
(43) Pub. Date: Aug. 22, 2013

(54) METHOD AND APPARATUS FOR COLLABORATIVE CONTEXT RECOGNITION

(71) Applicants: Happia Cao, Beijing (CN); Jilei Tian, Beijing (CN); Zheng Yan, Espoo (FI)

(72) Inventors: Happia Cao, Beijing (CN); Jilei Tian, Beijing (CN); Zheng Yan, Espoo (FI)

(73) Assignee: NOKIA CORPORATION, Espoo (FI)

(21) Appl. No.: 13/825,421

(22) PCT Filed: Sep. 21, 2010
(86) PCT No.: PCT/CN10/77201

§ 371 Date: May 2, 2013

(51) Int. Cl. H04L 29/08

(52) U.S. Cl. CPC H04L 67/22
USPC 709/204

(57) ABSTRACT

Techniques for collaborative context recognition include determining a plurality of groups of user types. Each different group is associated with a corresponding different range of values for an attribute of a user. First data is received, which indicates context data for a device and a value of the attribute for a user of the device. A particular group of user types to which the user belongs is determined based on the value of the attribute for the user. A context label based on the context data and the particular group is determined to be sent. Some techniques include determining a value of an attribute and context data based on context measurements. First data that indicates the context data and the value of the attribute is determined to be sent. A context label based on the context data and the value of the attribute is received.

### BACKGROUND

Service providers and device manufacturers (e.g., wireless, cellular, etc.) are continually challenged to deliver value and convenience to consumers by, for example, providing compelling network services. One group of network services provides context aware services that determine user location or activity context to adapt interfaces, tailor the set of application-relevant data, increase the precision of information retrieval, discover services, make the user interaction implicit, or build smart environments. However, the relevance of the services provided depends on the accuracy with which the user's context is recognized. Some researches and projects on context recognition utilize the background audio or three dimensional (3D) accelerometer signals. However, context recognition models trained with laboratory-generated test data experience difficulty in adapting to volatile real environments. For one reason, it is hard to collect comprehensive training data for the predefined contexts. For example, a model for detecting restaurants through the background sound, which is trained using the sound from western-style restaurants in Finland, typically does not recognize a Sushi restaurant in Beijing. For another reason, comprehensive training data may introduce conflicts. For example, houses of worship of different religions have very different background sound and it is difficult for a unified model to detect all houses of worship. Clearly, context recognition has a certain level of environmental dependency, such as location and culture dependency. To build a robust data-driven context recognition model, it is crucial to take advantage of multi-environment data.

### SOME EXAMPLE EMBODIMENTS

Therefore, there is a need for an approach for improved context recognition by adapting to environmental data collected by a large number of users of different types, such as users in different locations and cultures, called collaborative context recognition herein.

According to one embodiment, a method comprises determining a plurality of groups of user types, wherein each different group is associated with a corresponding different range of values for an attribute of a user. The method also comprises receiving first data that indicates context data for a device and a value of the attribute for a user of the device. The method further comprises determining, based on the value of the attribute for the user, a particular group of user types to which the user belongs. The method also comprises determining to send a context label based on the context data and the particular group.

According to another embodiment, a method comprises determining a value of an attribute for a user of a device. The method also comprises determining context data for a device based on context measurements at the device. The method further comprises determining to send first data that indicates the context data and the value of the attribute for the user of the device. The method also comprises receiving a context label based on the context data and the value of the attribute for the user of the device.

According to another embodiment, A method comprises determining movement of a plurality of users during a first time interval. The method further comprises determining a first user of the plurality of users and a first time within the first time interval. The method also comprises determining a group of users with a similar movement to the first user during the first time interval. The method further comprises determining a location statistic for the group of users.

According to another embodiment, a method comprises facilitating access to at least one interface configured to allow access to at least one service, the at least one service configured to perform at least the steps of one of the above methods.

According to another embodiment, an apparatus comprises at least one processor, and at least one memory including computer program code, the at least one memory and the computer program code configured to, with the at least one processor, cause, at least in part, the apparatus to perform at least the steps of one of the above methods.

According to another embodiment, a computer-readable storage medium carries one or more sequences of one or more instructions which, when executed by one or more processors, cause, at least in part, an apparatus to perform at least the steps of one of the above methods.

According to another embodiment, a computer program product includes one or more sequences of one or more instructions which, when executed by one or more processors, cause an apparatus to at least perform the steps of one of the above methods.

According to another embodiment, an apparatus comprises at least means for performing each of the steps of one of the above methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of collaborative context recognition, according to one embodiment;

FIG. 2A is a diagram of a hierarchy of context labels, according to an embodiment;

FIG. 2B is a diagram of groups defined in user property space, according to an embodiment;

FIG. 2C is a diagram of a hierarchy of groups of user types, according to an embodiment;

FIG. 3A is a diagram of a group context data structure, according to an embodiment;

FIG. 3B is a diagram of a message to request context, according to an embodiment;

FIG. 3C is a diagram of a message to update context, according to an embodiment;

FIG. 4 is a flowchart of a client process for collaborative context recognition, according to one embodiment;

FIGS. 5A-5B are diagrams of user interfaces utilized in the processes of FIG. 4, according to various embodiments;

FIG. 6A is a flowchart of a server process for collaborative context recognition, according to one embodiment;

FIG. 6B is a flowchart of a step of the process of FIG. 6A, according to an embodiment;

FIG. 6C is a flowchart of a different step of the process of FIG. 6A, according to an embodiment;

FIG. 7 is a diagram of hardware that can be used to implement an embodiment of the invention;

FIG. 8 is a diagram of a chip set that can be used to implement an embodiment of the invention;

FIG. 9 is a diagram of a mobile terminal (e.g., handset) that can be used to implement an embodiment of the invention;

FIG. 10 is a diagram of a movement group data structure, according to one embodiment; and

FIG. 11 is a flowchart of a server process for determining user location based on the movement group, according to one embodiment.

### DESCRIPTION OF SOME EMBODIMENTS

Examples of a method, apparatus, and computer program are disclosed for collaborative context recognition. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term context refers to data that indicates the state of a device or the inferred state of a user of the device, or both. The states indicated by the context include time, recent applications running on the device, recent World Wide Web pages presented on the device, keywords in current communications (such as emails, SMS messages, IM messages), current and recent locations of the device (e.g., from a global positioning system, GPS, or cell tower identifier), movement, activity (e.g., eating at a restaurant, drinking at a bar, watching a movie at a cinema, watching a video at home or at a friend's house, exercising at a gymnasium, travelling on a business trip, travelling on vacation, etc.), emotional state (e.g., happy, busy, calm, rushed, etc.), interests (e.g., music type, sport played, sports watched), contacts, or contact groupings (e.g., family, friends, colleagues, etc.), among others, or some combination. Thus, in some embodiments, context indicates a social environment in the vicinity of a device.

According to various embodiments, context is recognized based on measurements made by a device and on type of user. Measurements made by a device are called device measurements and include anything that can be detected by a user device, including time, geographic location, orientation, 3D acceleration, sound, light, network communication properties (such as signal strength, electromagnetic carrier frequency, noise level, and reliability), transmitted or received text or digital data, among other, alone or in any combination. Context measurement data comprises one or more device measurements used to define context or statistical quantities, such as averages, standard deviations or spectra, derived from such measurements, or some combination. A context label is a name used to reference the context and present the context to a human observer. Thus, audio data collected by a user device are example device measurements; and, the audio spectrum derived from the audio data is example statistical context data. An audio spectrum that is more similar to a cluster of audio spectra from many test restaurant audio files than to clusters of audio spectra for other test environments is given the example context label “restaurant.” Context data refers to context measurements or parameters of a context recognition model, or some combination.

A user type is defined herein by a set of values for a user attribute. A user attribute is a set of one or more parameters to describe a user type, such as geographic location of the user, governmental province encompassing location of the user, age of the user, gender of the user, movement of the user, local industry in geographic location of the user, applications installed on device of the user, profession or trade of the user, or semantic topics in messages exchanged with the device of the user, among others, alone or in some combination. As used herein a user property is a set of one of more values for corresponding parameters of the attribute. Thus a group of user types is defined by a range of values for each of the parameters of the user attribute, i.e., a user type is a range of user properties.

Although various embodiments are described with respect to user devices that are mobile terminals and user types based on governmental province alone, it is contemplated that the approach described herein may be used with other devices communicating through a communications network and user types defined based on attributes with more or different parameters.

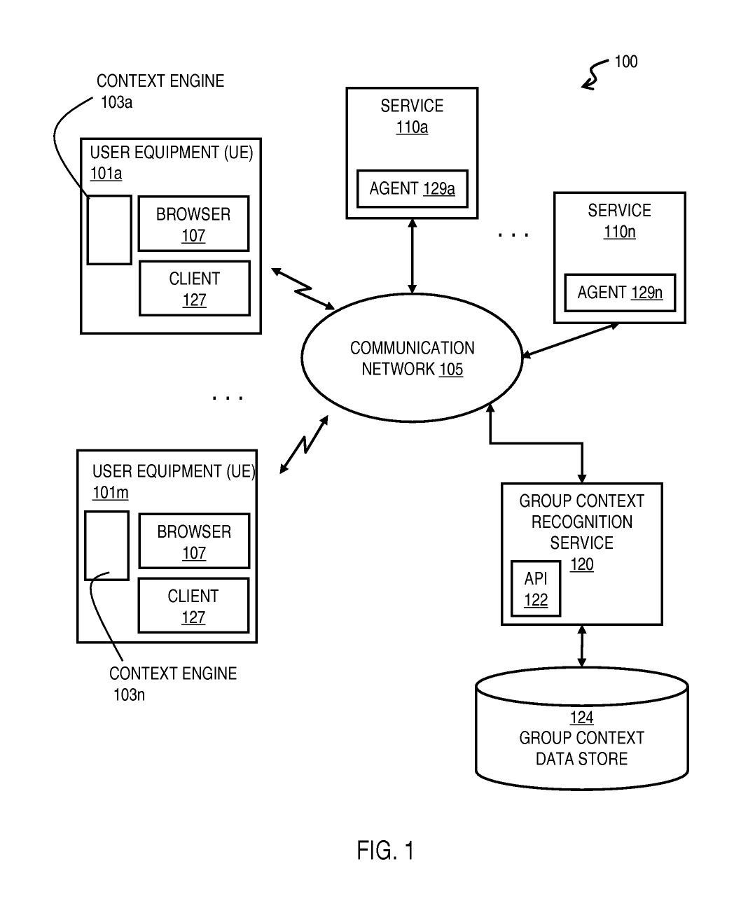

FIG. 1 is a diagram of a system 100 capable of collaborative context recognition, according to one embodiment. User equipment (UE) 101a through UE 101m (collectively referenced hereinafter as UE 101) communicate with one or more network services 110a through 110n (collectively referenced hereinafter as network services 110) through communication network 105. Device measurements at UE 101 are used to derive statistical quantities in context engines 103a through 103m (hereinafter referenced as context engines 103) on UE 101a through UE 101m, respectively. In some embodiments, the context engine 103 determines the context and associated context label. In some embodiments, the statistical quantities are sent to one or more or the services 110 to determine context at the UE 101. The context, identified by the context label, is used to provide context-aware service, e.g., choose the most relevant data or application to send to the UE in response to an ambiguous request, or to redirect the user to a different network service 110. However, as described above, determining the context (and associated label) based on the statistical quantities is prone to error due to limited training sets or due to contradictory results from different cultures or regions, or some combination.

To address this problem, the system 100 of FIG. 1 introduces the capability to group context recognition training data by types of users, or to allow users to add to the training sets, or both. According to the illustrated embodiment, group context recognitions service 120 uses different context recognition training data for different groups of user types. Thus context labels are derived by the service 120 from device measurements or statistical quantities based on the type of user. By modelling a more homogeneous user group, more precise context labels are expected. Any context recognition training algorithm may be used, such as expectation maximization (EM) models like Baum-Welch EM-learning algorithm or support vector machine (SVM) models, among others. Furthermore, when a context label provided by service 120 to UE 101 does not agree with the context label that would have been assigned by a user of the UE 101, the context measurements and user selected context label are provided to the group context recognition service 120 to update the derivation of context label from device measurements or statistical quantities.

The server 120 is an example means to achieve the advantage that the adaptation data sharing is conducted by a back end server, so the client side context recognition model can still be kept simple with a small footprint. By using the input from multiple users, the system 100 is appropriate for a service business which has a large number of mobile users in growing markets where the training data for context recognition is sparse. Furthermore, a mobile user can take advantage of the adaptation to the context recognition model made by other mobile users who are similar to him or her. Even though each mobile user only makes one or two contributions of adaptation data, because there are so many users, the shared context recognition model of the user group still obtains enough training data for each user group.

As shown in FIG. 1, the system 100 comprises user equipment (UE) 101 having connectivity to network services 110 and group context recognition service 120 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, network services 110 and group context recognition service 120 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

Processes executing on various devices, often communicate using the client-server model of network communications, widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host on which the process operates. Similarly, the term “client” is conventionally used to refer to the process that makes the request, or the host on which the process operates. As used herein, the terms “client” and “server” refer to the processes, rather than the hosts, unless otherwise clear from the context. In addition, the process performed by a server can be broken up to run as multiple processes on multiple hosts (sometimes called tiers) for reasons that include reliability, scalability, and redundancy, among others. A well known client process available on most devices (called nodes) connected to a communications network is a World Wide Web client (called a “web browser,” or simply “browser”) that interacts through messages formatted according to the hypertext transfer protocol (HTTP) with any of a large number of servers called World Wide Web (WWW) servers that provide web pages. As depicted in FIG. 1, the UE 101 include browsers 107.

In addition, the UE 101a through 101m include corresponding context engines 103a through 103m, respectively, of varying sophistication, to determine the time, and one or more other environmental conditions, such as location, local sounds, local light, e.g., from built-in global positioning system, microphone and digital camera.

In some embodiments, the UE include a separate client 127 of the group context recognition service 120. In some embodiments, the client 127 is included within the context engine 103. In some embodiments, the browser 107 serves as a client to the group context recognitions service 120 and a separate client 127 is omitted.

In some embodiments, the client 127 is a client of a service 110 that communicates with the group context recognitions service 120. In some embodiments, the network services 110a through 110n include an agent process 129a through 129n, respectively (collectively called agent 129). The agent 129 intervenes in communications between the group context recognition service 120 and the client 127 or browser 107 and interacts with the network service 110.

The group context recognition service 120 includes a group context data store 124 that stores context data in association with information about the user type in each group. An API 122 allows other network services 110 to access the functionality of the group context recognition service 120, e.g., to incorporate into one or more World Wide Web pages or other applications provided by the other network services 110. The group context recognition service 120 acts indirectly with one or more UE 101 through a group context agent 129 on corresponding network services 110. For example, the network service 110 interacts directly with UE 101 through a World Wide Web browser 107 that presents pages provided and controlled by the network services 110 based on data exchanged with the group context recognition service 120 through agent 129 and API 122. In some embodiments, the group context recognition service 120 also acts directly with one or more UE 101, e.g., through a client process 127 that accesses the API 122 or through a World Wide Web browser 107 that presents pages provided and controlled by the group context recognition service 120.

Although processes and data structures are depicted in FIG. 1 as integral blocks in a particular arrangement for purposes of illustration, it is contemplated that the functions of these components, or portions thereof, may be combined in one or more components or performed by other components of equivalent functionality on the same or different or different number of devices connected to communication network 105.

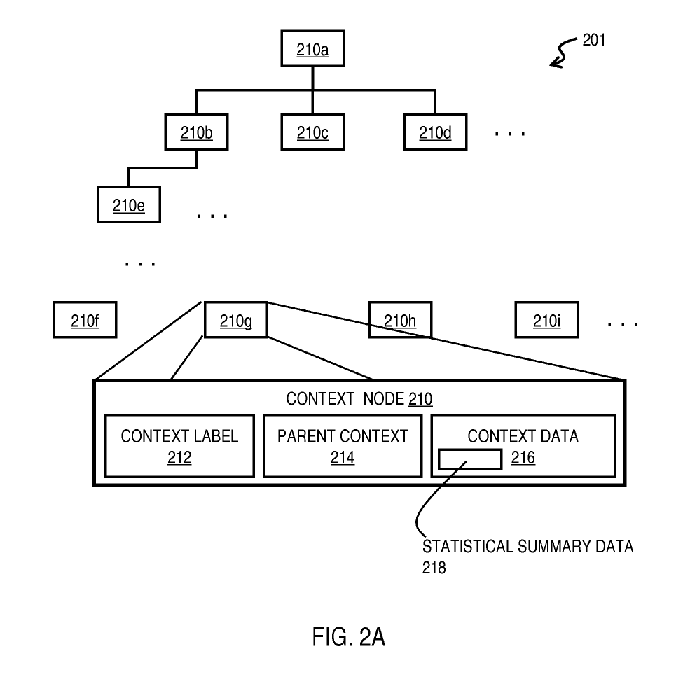

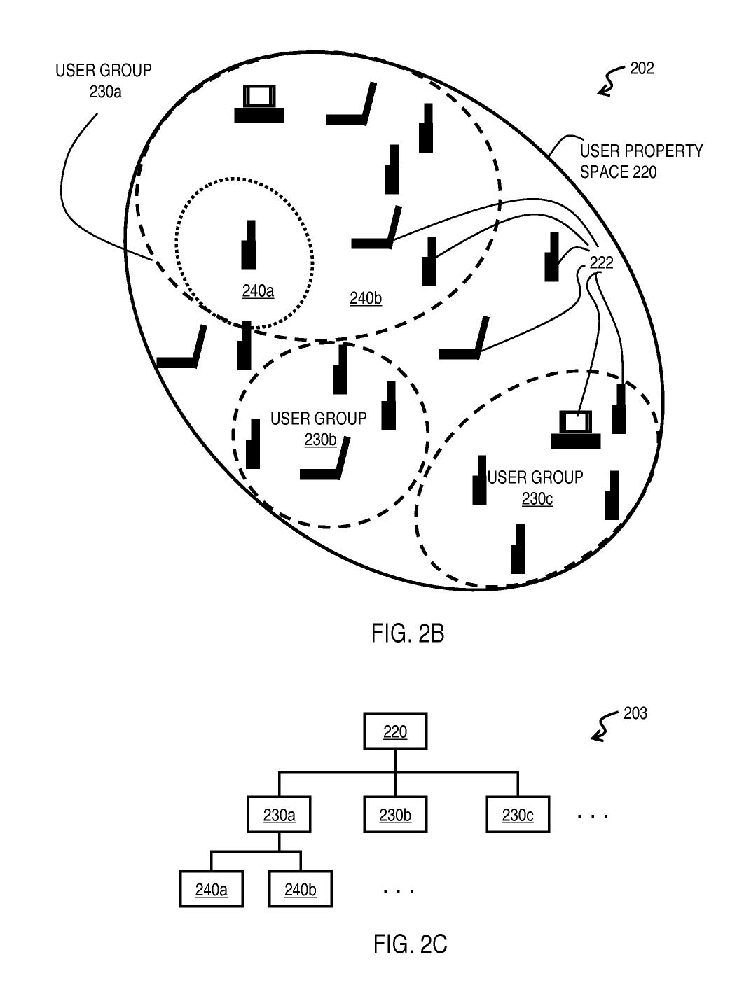

In some embodiments, a finite set of context labels are defined that are relevant for delivering context aware services. The finite set is arranged in a tree structure in which each node of the tree (except a root node) has one parent. Each node can have zero, one or more child nodes. A leaf node is a node with no child nodes. A label of a parent context node includes all labels of all of its child context nodes. For example, a context label for shopping includes context labels for clothes shopping, food shopping, hardware shopping, among others. FIG. 2A is a diagram of a hierarchy 201 of context nodes, according to an embodiment. In the illustrated embodiment, each context node 210 refers to a context label 212 associated with a parent context node 214 and context data 216, such as statistical summary data 218. Any method may be used to determine the statistical summary data 218 or other context data 216 to associate with the context label 212.

A root context node 210a includes all context nodes. A first level of child context nodes 210b, 210c, 210d among others indicated by ellipsis each indicate a different set of contexts, e.g., work, home, errand, entertainment, worship, etc., respectively. The next level of child nodes 210e among others represented by ellipsis, further divide the context encompassed by the parent. For example, child context nodes of the work context node 210b include office, construction site, retail, bank, etc, respectively. Similarly, additional levels of context detail are represented by ellipsis until the hierarchy ends with a set of leaf nodes 210f, 210g, 210h, 210i, among others indicated by ellipsis, at one or more levels of the hierarchy. Any method may be used to determine the parent child relationship indicated by the parent context node 214.

In prior approaches one set of context nodes is defined for all users, regardless of user type, i.e., regardless of values of a user attribute. As stated above, such an approach can lead to conflicting training sets that make accurate context recognition difficult or impossible. According to various embodiments, a different set of context nodes is defined for different groups of user types by the group context recognition service 120. In some of these embodiments, the hierarchy of context labels is the same (e.g., with the same number of nodes at each level, with the same parent child relationships, and with the same labels); however, the context data 216 for at least some nodes are different for different groups of user types. In some embodiments, the hierarchy is also different, with one or more context nodes omitted or additional context nodes added at one or more levels. By defining multiple groups of user types, the number of training data sets available for any one context label for one group is reduced. Therefore, according to some embodiments, the training sets originally used to recognize a context label are augmented by user experience during deployment of the group context recognition service 120. Thus, the users who contribute training data become collaborators in the collaborative context recognition.

FIG. 2B is a diagram 202 of groups defined in user property space 220, according to an embodiment. As described above, a user property is a value for all the parameters of a user attribute employed to define user types. In some embodiments the user attribute is a single parameter, such as governmental province (e.g., section in municipality in region in country in continent), an individual user has a single value (e.g., Yizhuang of Beijing of central region of China of Asia) and the user property space is one dimensional. In some embodiments, the attribute includes multiple parameters, such as governmental province and gender and age, for a three dimensional attribute. The user property is described by multiple dimensional vector of values (e.g., a three dimensional vector comprising Yizhuang . . . , female, 26) and the user property space 220 is multi-dimensional. Even higher dimensions are possible, e.g., adding profession as a fourth parameter to produce a four dimensional user space 220. No matter the dimensionality of the space, a single user is represented by a point in the user property space 220. A group of similar users is evident as a cluster of points in the user property space 220. Many methods of cluster analysis are well known.

For purposes of illustration, the UE 101 of several users are represented as symbols 222 in the user property space centered on points that represent the property of the user of the device. Symbols for mobile telephones, laptop computers and desktop computers are shown.

It is expected that different groups of users may experience a different relationship between device measurements and context labels. For example, a restaurant in Finland is expected to have different sights and sounds than a restaurant in China. Thus the user property space 220 is divided up into different user groups, wherein each group represents multiple users of similar type. The users who are grouped in the same type have properties that cover a region of the user property space 220; thus each group covers a portion of the space 220. In the illustrated embodiment, the user space 220 is divided into user group 230a, user group 230b, user group 230c. Defining multiple user groups is an example means for achieving the advantage of more precise context recognition in more homogeneous user groups that span multiple regions or cultures.

In some embodiments, the user groups are defined by objective methods, such as cluster analysis of user properties; and similarity measures of a point (user property) to the cluster (e.g., distance from outer edge of the cluster) is used to determine whether the point is included in one group or another. Any similarity measure may be used. Objective measures of defining user groups is an example means of achieving fast and repeatable user groups.

In each group there are passive users, who use the context nodes for their group, and contributing users who contribute context data based on context measurements and associated context labels for context recognition. If a sufficient number of contributions are received, context recognition models can provide well defined results. Sending context data and associated context labels from user equipment to a server is an example means to achieve the advantage of building up sufficient statistics to accurately recognize context in multiple user groups.

In some illustrated embodiments, the similarity threshold to group users is adaptive to the number of contributing users. This approach ensures each user group has enough contributing users to recognize all the context nodes in the hierarchy. For example, the similarity measure threshold for being included in a group increases as the number of contributing users increases. When the number of contributing users in one user group increases to a particular number, the user group may split into multiple smaller user groups where the users in the same user group are more similar. For example, user group 230a is divided into two child groups, group 240a and a residue group 240b, because the number of contributing users in group 230a has exceeded the particular number. The contributing user in group 240a is no longer similar enough to meet the new similarity threshold. Thus, as the number of contributing users increases, a parent user group is split into two or more child user groups, forming a hierarchy of user groups. Splitting a user group with excess contributing users into multiple child groups is an example means of achieving the advantage of more precise context recognition due to a more homogeneous user group.

A range of user properties for a parent user group includes all user properties of all of its child user groups. For example, a range of user properties for a user group for Beijing includes the ranges of user properties for child user groups Yizhuang and Dongdan, among others. FIG. 2C is a diagram of a hierarchy 203 of groups of user types, according to an embodiment. In the illustrated embodiment, the user property space 220 is the root node, the primary user groups 230a, 230b and 230c, among others, are the first level child nodes, and the newly split user group 240a and 240b are the next level child nodes of user group 230a.

If a child user group has too few contributing users, then users that are similar to the type of the child user group invoke the context recognition model of the parent user group. Invoking the parent group's context recognition models is an example means of providing a statistically sound context recognition model while a child group has not yet assembled a sufficient number of contributing users to provide high confidence context recognition model.

In an illustrated embodiment, a child node should have a minimum number of contributing users, called a contribution threshold in order to invoke the context recognition models of the child user group. If the number of contributing users is less than the predefined contribution threshold, the context recognition models of the parent are used. By the same token, a user group that has a number of contributing users that exceeds a larger threshold, for example a factor of about two or more times the contribution threshold, is large enough to split into two or more child user groups.

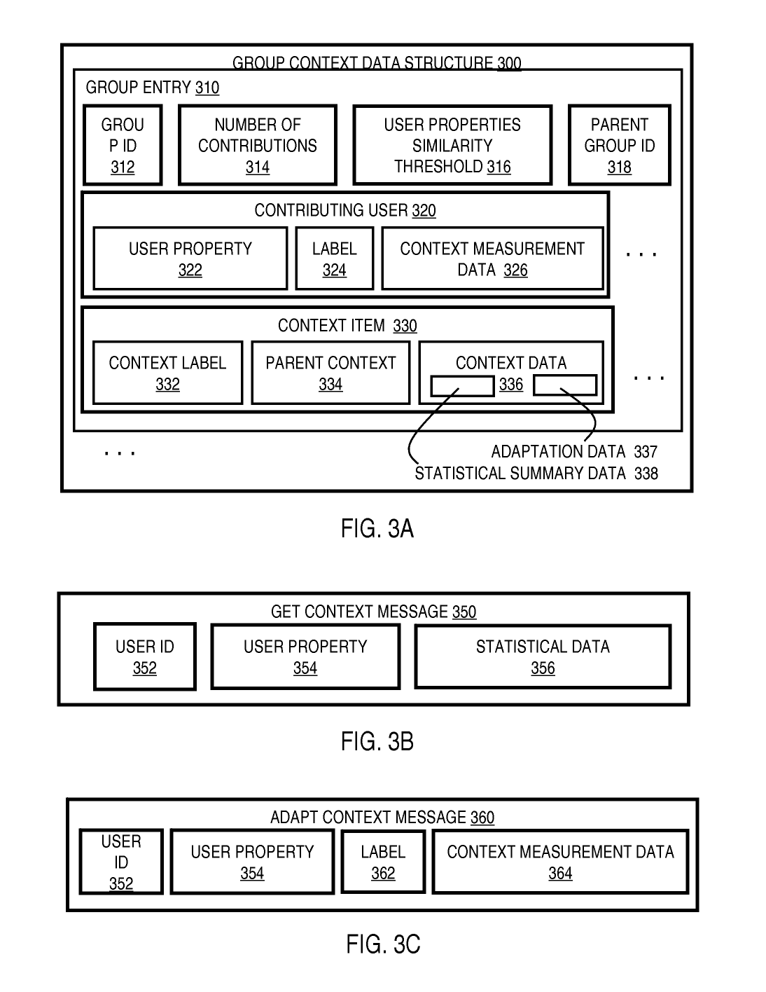

FIG. 3A is a diagram of a group context data structure 300, according to an embodiment. Data structure 300 is a particular embodiment of group context data store 124 depicted in FIG. 1. Although fields are shown as integral blocks in a particular order in a single data structure in FIG. 3A, or single message in following FIG. 3B and FIG. 3C, for purposes of illustration, in other embodiments, one or more fields or portions thereof are arranged in a different order in one or more data structures or databases or messages, or are omitted, or one or more additional fields are added, of the data structures or message is changed in some combination of ways.

In the illustrated embodiment, data structure 300 includes a group entry field 310 for each user group, with entry fields for additional user groups indicated by ellipsis. According to this embodiment, each group entry field 310 includes a group identifier (ID) field 312, a number of contributions field 314, a user properties similarity threshold field 316, a parent group ID field 318, one or more contributing user fields 320, and one or more context item fields 330.

The group ID field 312 holds data that uniquely identifies the user group, such a sequence number or a hierarchy level and sequence number. The number of contributions field 314 holds data that indicates a number of contributions of context data and associated context labels provided by a user who falls with the user type of the group.

The user properties similarity threshold hold data that indicates a threshold of similarity to a cluster of user properties that define the user group, within which a user's property must fall to be considered a member of the group. Any method may be used to define the similarity threshold. For example, in some embodiments, the similarity threshold is expressed as a distance in user property space from a center of mass of user properties of users already members of the group. In some embodiments, the similarity threshold is expressed as a multiplicative factor of a standard deviation of distances of users already members of the group from the center of mass of the group. Distance in an arbitrary dimension space (such as in a one dimensional user property space or a four dimensional user property space) can be expressed in any method known in the art. For example, in some embodiments, distance is the Euclidean distance that is a square root of a sum of the squares of the distance in each of the dimensions. In some embodiments, the distance is a higher order root of a sum of the distances raised to the higher order. In some embodiments, the distance is a sum of absolute values of the distances in each of the dimensions. In some embodiments, the distance is the largest absolute value of the distances in each of the dimensions. In some embodiments, the user properties similarity threshold field 316 also holds data that indicates the center of mass of the cluster of contributing users already in the group, and the standard deviation of the distances from the center of mass.

The parent group ID field 318 holds data that indicates a parent user group, if any, of the user group of the current group entry record 310.

Each contributing user field 320, among other indicated by ellipsis, includes a user property field 322, a label field 324 and a context measurement data field 326. The number of contributing user fields 320 is indicated by the value in field 314.

The user property field 322 holds data that indicates the user property of a contributing user, e.g., values for each of the parameters of the attribute used to define user types. For example, the user property field holds data that indicates “Yizhuang” for the one dimensional attributed based on governmental province. Thus the collection of all the values in fields 322 for all fields 320 in the group entry record 310 defines the cluster of user properties that make up one type of user—the user type for the group identified in field 312. Thus, by virtue of contributing user fields 320 and user properties similarity threshold field 316, each different group is associated with a corresponding different range of values for an attribute of a user.

The label field 324 holds data that indicates a user-selected context label, such as one of the context labels in the context node hierarchy 201, as selected by the contributing user with the property indicated in field 322.

The context measurement data field 326 holds data based on device measurements that are associated by the user with the label indicated in field 324. In some embodiment, the context measurement data comprises device measurements such as an audio clip or video clip or a time series of 3D accelerations or some combination. In some embodiments, the context measurement data comprises data derived from device measurements, such as an audio spectrum, video spectrum or acceleration spectrum, or some combination, which, in general, involves a much smaller amount of data. The context measurement data are intended to be used to re-train a context recognition model to produce the context label indicated in field 324.

Each context item field 330, among other indicated by ellipsis, includes a context label field 332, a parent context field 334 and a context data field 336. The number and levels of context labels is predetermined by the hierarchy 201; and there is a corresponding context item field 330 for each context label in the hierarchy 201. The group of context items constitutes the context model for the user group indicated in field 312.

The context label field 332 holds data that indicates one of the predetermined context labels of the hierarchy 201. The parent context field 334 holds data that indicates the context item, such as the parent context label, of the parent context in the hierarchy.

The context data field 336 holds context data, such as adaptation data in field 337 or statistical summary data in field 338, or both. The adaptation data field 337 holds data that indicates training data to re-train the context recognition model based on user contributions. In some embodiments, the adaptation data field indicates the context measurement data fields 326 of all the contributing user fields 320 for the user group identified in field 312. In some embodiments, the adaption data field 337 holds the actual data; and, in some embodiments, the field 337 holds pointers to the context measurement data field 326 in all contributing user fields 320 that have a context label in field 324 that matches the context label in field 332. In some embodiments, field 337 is omitted, and the adaptation data is retrieved, when needed, from the context measurement data fields 326 of the contributing user fields 320.

The statistical summary data field 338 holds the data that defines the context model for the group identified in field 312. For example, the statistical summary data field 338 holds data that indicates a range of audio or optical or acceleration spectral values at one or more frequencies, or some combination, or some function thereof, to be associated with the context label indicated in field 332. In some embodiments, the statistical summary data field 338 includes data that indicates a confidence level in the context recognition using the model. In many embodiments, the context level depends on the number of contributing users or the spread of the context measurement data associated with the one context label, or some combination.

Thus the data structure 300 is an example means to associate a definition of user types in each group based on fields 320 with the context recognition model for the group based on fields 330. This offers the advantage of defining more precise context models tailored to the regional or cultural environment of the user.

FIG. 3B is a diagram of a message 350 to request context, according to an embodiment. This is called a get context message 350, hereinafter; and, is used by even passive users of the system 100 who do not contribute to the context model. In the illustrated embodiment, the message 350 includes a user identifier (ID) field 352, a user property field 354, and a statistical data field 356.

The user ID field 352 holds data that indicates an individual user of the system who sends the message 350, e.g., an Internet Protocol (IP) address, a mobile telephone number, an email address, or a user name. In some embodiments, field 352 is omitted.

The user property field 354 holds data that indicates the user property of the user who sends the message, e.g., the values of the one or more parameters of the user attribute to define the groups. In some embodiments, the server process that receives the message 350 (e.g., group context recognition service 120) maintains a mapping of user ID as indicted in field 352 with the corresponding user property, and field 354 is omitted. At least one of field 352 or field 354 is included in message 350; and is used to determine the user's type, and therefore the corresponding group.

The statistical data field 356 holds data that indicates values of derived parameters of device measurement on the device that sends the message 250. The values of derived parameters are in the form to be compared to the statistical summary data 338 in a group model of the corresponding group, in order to determine the associated context label. For example, the statistical data field 356 holds data that indicates a particular audio or optical or acceleration spectral value at one or more frequencies, or some combination, or some function thereof, to be compared to the ranges in fields 338 of one or more context item fields 330 of the corresponding group.

In some embodiments, the statistical summary data 338 for a context label for a corresponding group is available on the client side, e.g., in client 127, and the get message 350 is not employed.

FIG. 3C is a diagram of a message 360 to update context, according to an embodiment. This is called an adapt context message 360, hereinafter; and, is used by contributing users of the system 100. In the illustrated embodiment, the message 360 includes a user identifier (ID) field 352, a user property field 354, a label field 362, and a context measurement data field 364. The user ID field 352 and user property field are as described above for get context message 350. At least one of field 352 or field 354 is included in message 360; and is used to determine the user's type, and therefore the corresponding group.

The label field 362 holds data that indicates one of the predetermined context labels selected by the user identified in one or both of fields 352 or 254. Data in one field 324 of one contributing user field 320 in the group entry field 310 of the corresponding group is based on the data in this label field 362.

The context measurement data field 364 holds data that indicates data based on device measurements on the device used by the user who sends message 360. The data in field 364 is associated by the user with the label indicated in field 362. In some embodiment, the context measurement data comprises device measurements such as an audio clip or video clip or a time series of 3D accelerations or some combination. In some embodiments, the context measurement data comprises data derived from device measurements, such as an audio spectrum, video spectrum or acceleration spectrum, or some combination, which, in general, involves a much smaller amount of data. Data in the field 326 of the same contributing user field 320 in the group entry field 310 of the corresponding group is based on the data in this context measurement data field 364.

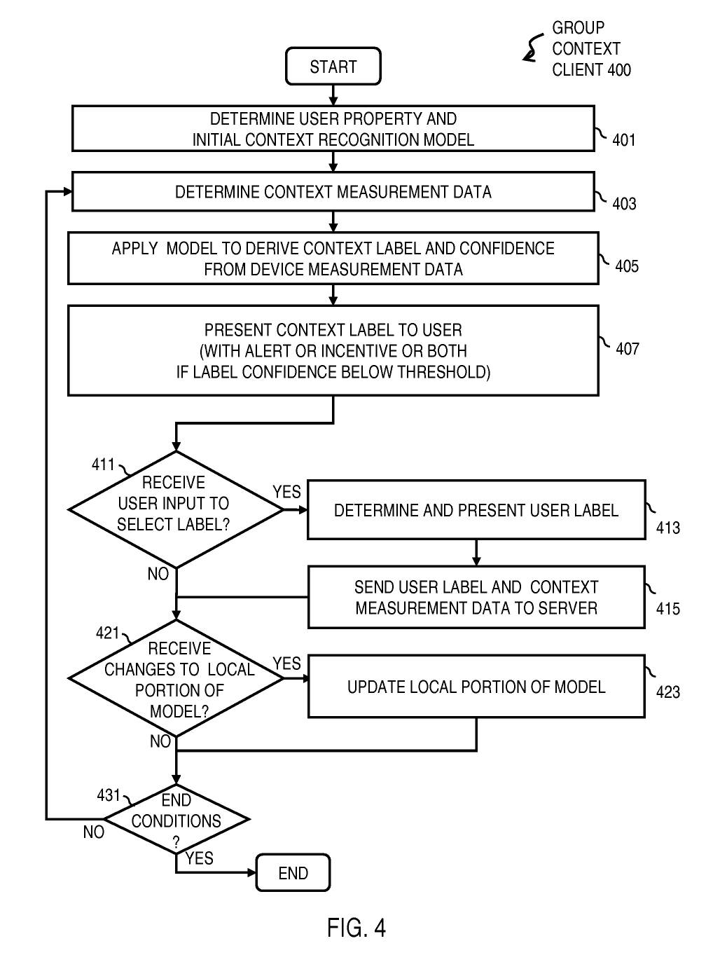

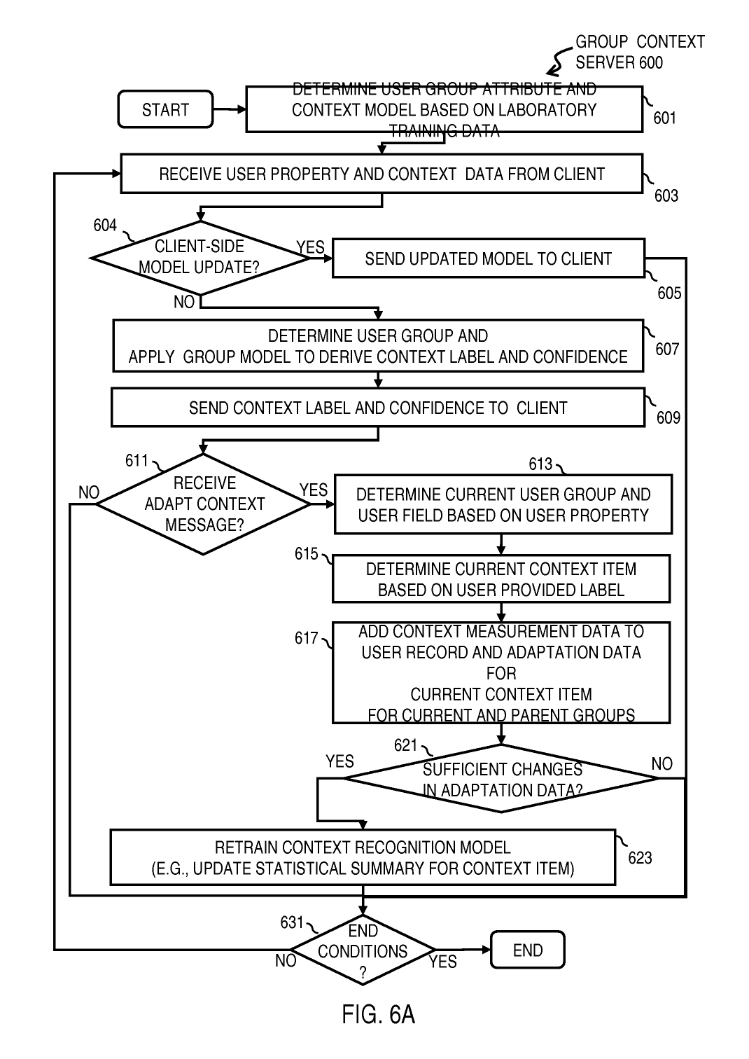

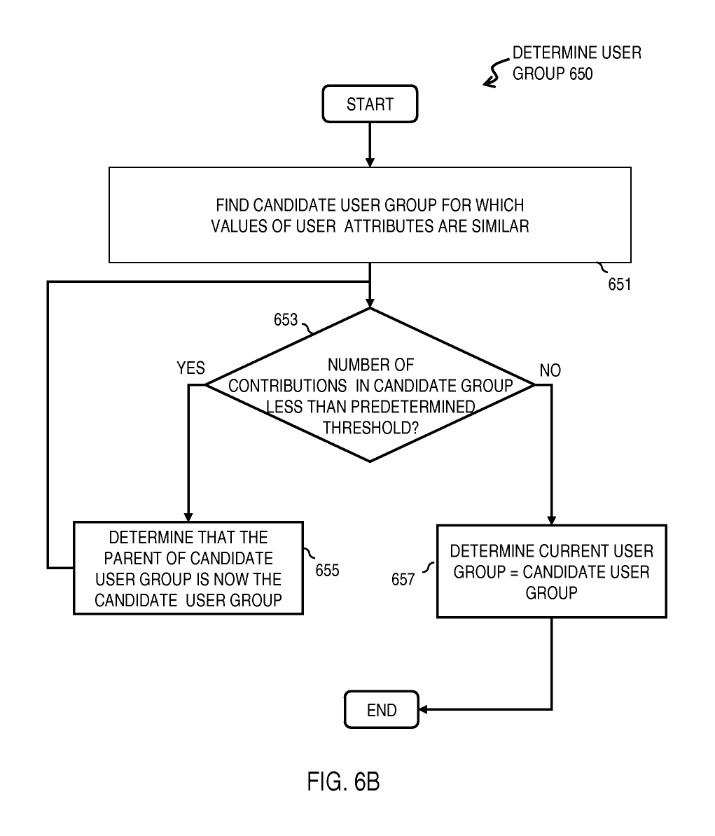

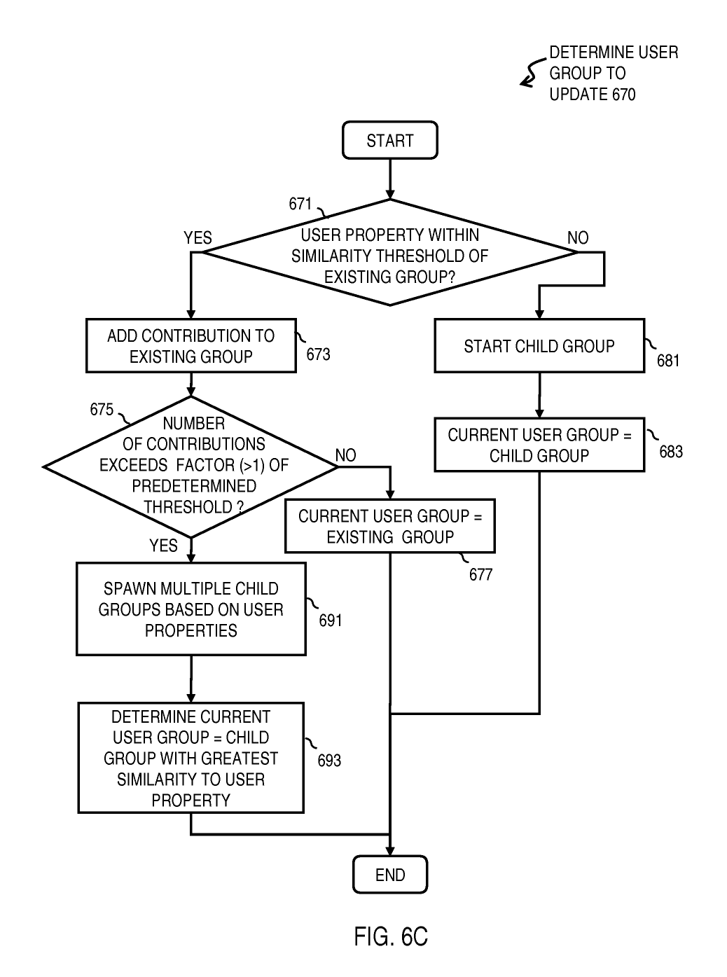

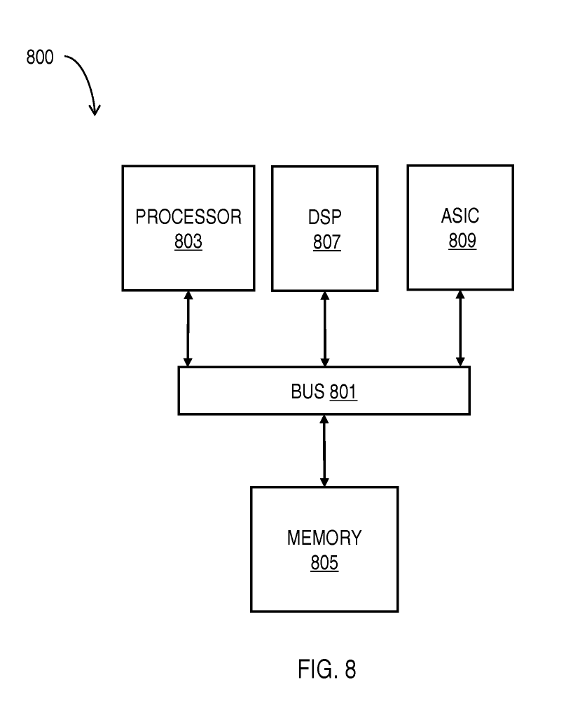

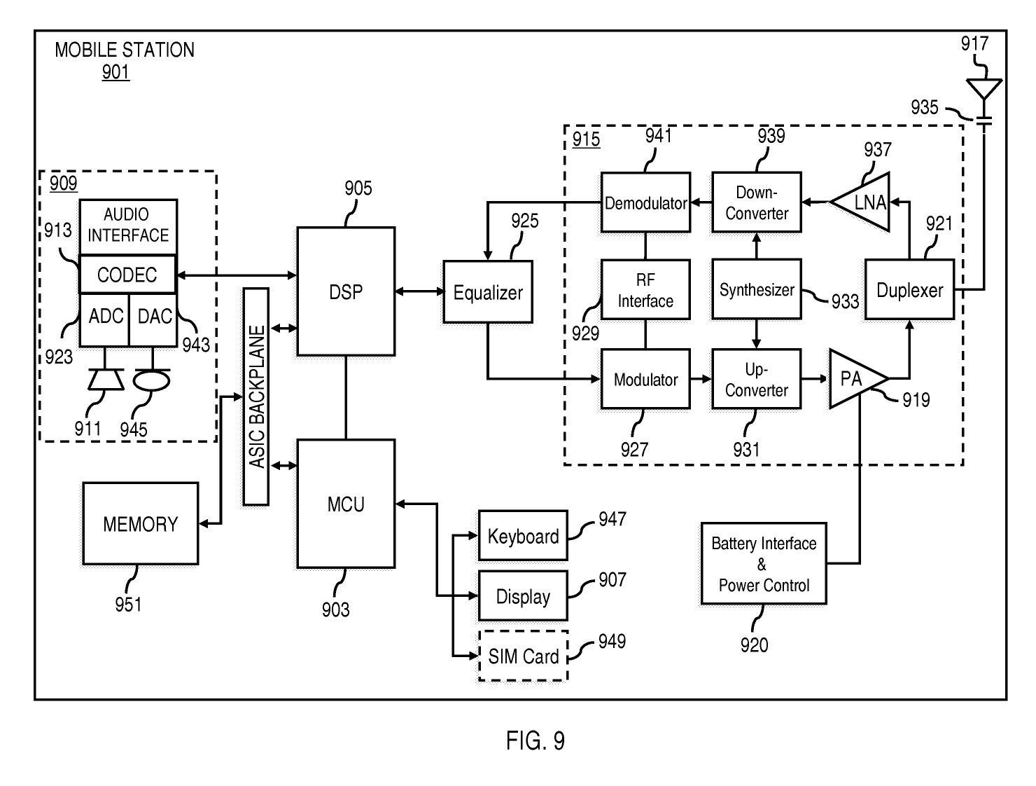

FIG. 4 is a flowchart of a client process for collaborative context recognition, according to one embodiment. In one embodiment, the client 127 performs the process 300 and is implemented in, for instance, a chip set including a processor and a memory as shown in FIG. 8 or a mobile terminal as shown in FIG. 9. Although steps are depicted in FIG. 4, and subsequent flowcharts FIG. 6A, FIG. 6B, FIG. 6C and FIG. 11, as integral blocks in a particular order for purposes of illustration, in other embodiments, one or more steps, or portions thereof, are arranged in a different order, or overlapping in time, in series or in parallel, or are omitted, or one or more additional steps are added, of the method is changed in some combination of ways.

In step 401, the user property is determined, e.g., the values of one or more parameters of a user attribute are determined. For example, based on location data from a global positioning system (GPS) receiver, the governmental province of the device, and hence the governmental province of the user, is determined. As a further example, in some embodiments, based on a user identifier, such as a cell telephone number, and registration information for the user's network service, the age and gender of the user are also determined. In some embodiments, based on one or more recurrent semantic concepts in user messages, the profession or trade of the user is also determined. Thus, step 401 includes determining a value of an attribute for a user of a device.

In some embodiments, step 401 also includes determining a client side portion of an initial context recognition model. The client side portion is the portion of the model that describes any data processing to be performed on the client side, such as statistical quantities to be derived from, or data to be received from, one or more built-in sensors. In various embodiments, the initial model is the context recognition based on laboratory training, or a context recognition model based on both laboratory training sets and adaptive training sets previously provided by contributing users. In some embodiments, the initial context recognition model is a generic model that does not consider user group membership.

In step 403, context measurement data is determined for the local device, e.g. for UE 101a. Any method may be used to determine the context measurement data, such as requesting the device measurement data from a context engine 103 on the device, or interrogating one or more sensors built into or otherwise in the vicinity of the device, or interrogating applications executing on the device. Any device measurements may be used, depending on the context model. For example, in various embodiments, context measurements data includes measurements of time, audio time series, optical time series, acceleration time series, a list of applications or application types currently or recently running on the device, or keywords or semantic concepts in recent messages sent or received at the device, or some combination thereof. In some embodiments, step 403 includes deriving statistical data from the data returned from one or more sensors, such as the mean, standard deviation, or spectrum of variations in the sensor data time series. The context measurements data includes one or more of the device measurements data or the statistical data. Thus, step 403 includes determining context data for a device based on context measurements at the device.

In step 405, a model of context recognition is applied to derive a context label, or context label and confidence value, from the context measurement data. Any method may be used. In some embodiments, a context recognition model process for the user group of which the user of the device is a member is downloaded on demand from the group context recognition server 120. In these embodiments, the context recognition model is applied by the client 127 during step 403. In some embodiments, the statistical data based on the device measurement data is sent to the group context service 120 and a return message providing the context label is received during step 405. Thus, step 405 includes determining to send first data that indicates the context data and the value of the attribute for the user of the device; and, receiving a context label based on the context data and the value of the attribute for the user of the device.

In some embodiments, a confidence level is also, determined during step 405. In some embodiments, the confidence level is qualitative, e.g., with values such as “low,” “moderate” or “high.” In some embodiments, the confidence level is quantitative, such as a number of training data sets used to derive the model, or a statistical degree of confidence like percent of group variance explained by the model. Thus, step 405 includes receiving a confidence measure associated with the context label.

In step 407, the context label for the user's current context is presented on the user device, e.g., on UE 101a. In some embodiments, an alert, such as a flashing highlighted area on a display screen or an audio beep, is also presented—indicating a new context label has been presented. In some embodiments, the alert is only presented if the confidence of the context label is below a predetermined confidence threshold, to indicate that user review of the context label is warranted. In some embodiments in which user review of the context label is warranted, an incentive to review the context label is also provided, such a monetary reward or a discount on a service related to the context label after review. Thus, step 407 includes presenting an alert if the confidence measure is below a confidence threshold.

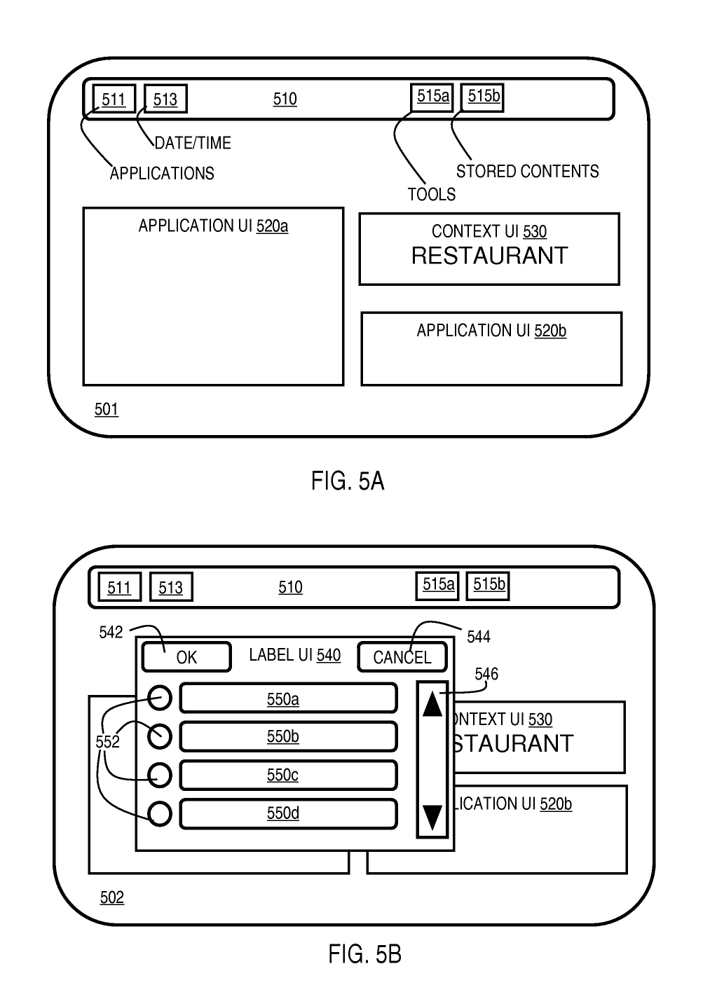

FIGS. 5A-5B are diagrams of user interfaces utilized in the processes of FIG. 5, according to various embodiments. FIG. 5A is a diagram that illustrates an example screen 501 presented at UE 101. The screen 501 includes a device toolbar 510 portion of a display, which includes zero or more active areas. As is well known, an active area is a portion of a display to which a user can point using a pointing device (such as a cursor and cursor movement device, or a touch screen) to cause an action to be initiated by the device that includes the display. Well known forms of active areas are stand alone buttons, radio buttons, pull down menus, scrolling lists, and text boxes, among others. Although areas, active areas, windows and tool bars are depicted in FIG. 5A through FIG. 5B as integral blocks in a particular arrangement on particular screens for purposes of illustration, in other embodiments, one or more screens, windows or active areas, or portions thereof, are arranged in a different order, are of different types, or one or more are omitted, or additional areas are included or the user interfaces are changed in some combination of ways.

For purposes of illustration, it is assumed that the device toolbar 510 includes active areas 511, 513, 515a and 515b. The active area 511 is activated by a user to display applications installed on the UE 101 which can be launched to begin executing, such as an email application or a video player. The active area 513 is activated by a user to display current context of the UE 101, such as current date and time and location and context label. In some embodiments, the active area 513 is a thumbnail that depicts the current time, or signal strength for a mobile terminal, or both, that expands into a context area 530 (also called a context widget) when activated. The active area 515a is activated by a user to display tools built-in to the UE, such as camera, alarm clock, automatic dialer, contact list, GPS, and web browser. The active area 515b is activated by a user to display contents stored on the UE, such as pictures, videos, music, voice memos, etc.

The screen 501 also includes one or more application user interface (UI) areas, such as application UI area 520a and application UI area 520b, in which the data displayed is controlled by a currently executing application, such as a local application like a game or a client process of a network service 110, or a browser 107.

The screen 501 also includes the context UI area 530, in which is displayed the current context label deduced by the context recognition model based on device measurements at the local device UE 101. For example, the context label “restaurant” is presented in the context UI 530. It is assumed for purposes of illustration that, if the confidence associated with the label “restaurant” is below the confidence threshold, then an alert is presented at the UE 101. For example, in some embodiments, at least a portion of the context UI area 530 flashes a bright yellow color on and off. In some embodiments, an audio beep is sounded, in addition to or instead of flashing the bright yellow color. In some embodiments, the UE 101 is caused to vibrate, in addition to or instead of flashing the bright yellow color or beeping. In some embodiments, the context UI area 530 also includes a message that provides an incentive to review the context label, such as a text box or other graphic that reads “Touch here to earn prize.”

It is further assumed, that if the user activates the context UI area 530, a context label user interface (UI) is presented. FIG. 5B is a diagram that illustrates an example screen 502 presented at UE 101. The screen 502 includes the device toolbar 510 portion as well as a context label user interface (UI) area 540. In the illustrated embodiment, the context label UI area 540 partially obscures the applications UI areas 520a, 520b and context UI area 530. The context label UI area 540 includes active areas for the user to confirm or change the context label. For example, if the user is currently in a restaurant, then the user should confirm the label “restaurant;” but, if not, then the user should select a more appropriate label. For purposes of illustration, it is assumed that the user is actually in a nature museum.

In the illustrated embodiment, the context label UI area 540 includes active areas 550a through 550d to indicate one of the predetermined context labels of the hierarchy 201. In some embodiments, the context label UI area 540 is generated by the client 127 on the UE 101. In some embodiments, the context label UI area 540 is a web page opened in a browser 107 on the UE 101 by the group context recognition service 120. In some embodiments, the context label UI area 540 is a web page sent from the group context recognition service 120 to an agent 129 on a network service 110 and is opened in a browser 107 on the UE 101 by the network service 110.

In the illustrated embodiment, the context label UI area 540 includes an OK button 542, a CANCEL button 544, a scroll bar 546 and a list of predetermined context labels that can be selected in context label areas 550a through 550d (collectively referenced hereinafter as context label areas 550). Next to each context label area 550 is a radio button 552 that is empty except for the one context label that is selected. When the context label UI 540 opens, the list is positioned with the “restaurant” context label among the viewable areas 550, e.g., in context label area 550b, and the corresponding radio button 552 filled. Other context labels can be brought into view in the context label UI area 540 by activating the scrollbar 546 to move up or down in the list.

The OK button 542 is activated by a user when the user is finished with confirming or changing the context label. The CANCEL button 544 is activated by a user when the user does not wish to confirm or change the context label, e.g., if a better label is not among the predefined labels presented. In either case, the context label UI area 540 is closed, revealing any active areas formerly obscured by the area 540.

Returning to FIG. 4, in step 411 it is determined whether the users has selected a context label to either confirm or change a context label, e.g., whether the user has activated the OK button 542 on screen 502. If so, then in step 413, the user selection is determined and presented on the user device. For example, if the user has pressed the OK button, then the context UI area 530 drops the alert, e.g., eliminates the beep and the flashing bright yellow color. If the user has confirmed, then the previous label is still presented in the context UI area 530 (e.g., “restaurant” still appears in context UI area 530). If the user has selected a new context label, then the new context label is presented in the context UI area 530 (e.g., “museum” now appears in context UI area 530). Thus, step 411 includes determining a user-selected context label based on input from a user of the device. Step 411 also includes determining to present, on a display of the device, data that indicates one of the context label or the user-selected context label.

In step 415 the user-selected label determined in step 413 and context measurement data determined in step 403 are sent to the group context recognition server 120, e.g., in fields 362 and field 362, respectively, in adapt context message 360. In the illustrated embodiment, at least the user property data determined in step 401 is included in field 354 of the adapt context message 360, during step 415. Thus, step 415 includes determining to send second data that indicates the context measurements and the user-selected context label.

If it is determined in step 411 that user input to select a context label is not received, e.g., if the user has activated the CANCEL button 544, or after step 415, control passes to step 421. In step 421, it is determined if any changes to the local portion of the context recognition model have been received. For example an update message is received to change the device measurements or derived statistics or function in the client portion of the context recognition model. If so, then in step 423, the local portion of the context recognition model is updated.

In step 431, it is determined whether end conditions are satisfied, such as powering down the UE, or closing the context UI area 530. If so, the process ends; otherwise control passes back to step 403 and following to determine context measurement data for a subsequent time interval.

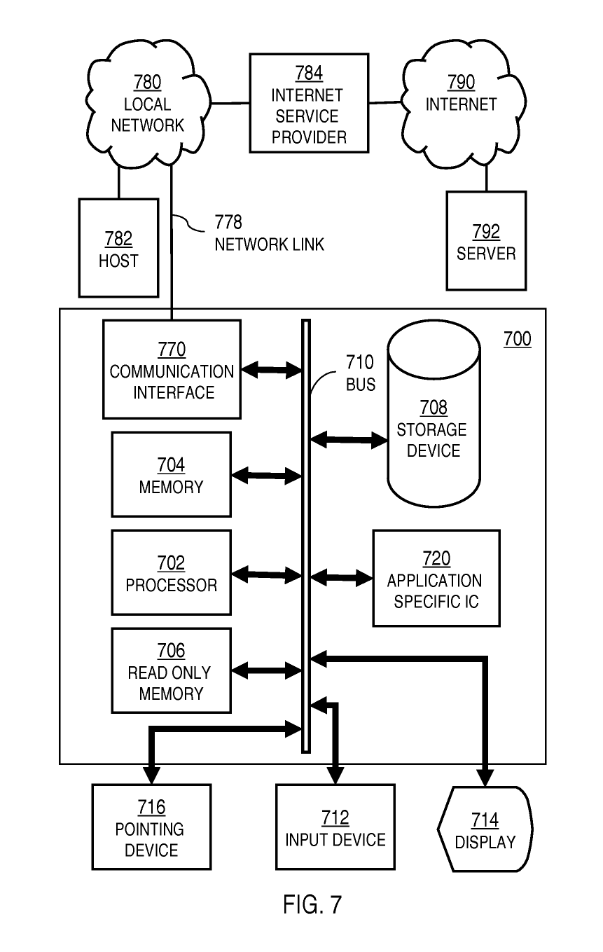

FIG. 6A is a flowchart of a server process 600 for collaborative context recognition, according to one embodiment. In one embodiment, the group context recognition server 120 performs the process 300 and is implemented in, for instance, a chip set including a processor and a memory as shown in FIG. 8 or a general purpose computer as depicted in FIG. 7. In some embodiments, one or more steps, or portions thereof, are performed by an agent 129 on a network service 110 or by the client 127 on UE 101.

In step 601, user groups and one or more initial context recognition models are trained based on laboratory training data. In some embodiments step 601 includes determining the context label hierarchy 201 and statistical summary data 218 for each context label based on laboratory training data comprising one more context measurements data sets. Any model training methods may be used, including EM and SVM learning algorithms. In some embodiments, step 601 includes determining multiple context recognition models for a corresponding multiple of user groups based on laboratory training sets from each of the multiple user groups. For example, a different laboratory training set is used for six user groups corresponding to each populated continent on Earth.

Step 601 also includes determining the user attribute parameters for defining user groups. For purposes of illustration, it is assumed that a single dimensional attribute comprising the parameter government province is used to define user groups. In other embodiments, one or more different or different number of parameters is used to define user groups. Thus, step 601 includes determining a plurality of groups of user types, wherein each different group is associated with a corresponding different range of values for an attribute of a user.

In step 603, data indicating a user property of an individual user and context data from that user are received. For example, a get context message 350 is received from a client 127 attempting to find the current context label for the current environment of the client device, e.g., UE 101. In the illustrated embodiment, the context data is the statistical data in field 356. In some embodiments, the context data is sensor measurements data or context measurement data derived therefrom. For purposes of illustration, it is assumed that a get message 350 from client 127 on UE 101a indicates that the user property is “Yizhuang, Beijing, central region, China, Asia” and the context data are audio spectra in 10 frequency bins and 3D acceleration spectra in four frequency bins. Thus, step 603 includes receiving first data that indicates context data for a device and a value of the attribute for a user of the device.

In step 604, it is determined whether there are any changes to the client side portion of the context recognition model, such as the data processing or statistical measure or function to derive context data from device measurements. If so, then in step 605, it is determined to send the new client side portion of the client recognition model to the client, e.g., a new version of the client 127 is installed on the UE 101. For example, if a context recognition model has been re-trained in step 623, described below, and if the new model involves a change to the context data derived on the client side from device measurements, then an updated version of client 127 that does the new derivation is installed on the UE 101 during step 605. For example, the model is re-trained to involve 20 audio frequency bins and six 1D acceleration frequency bins. In some embodiments, steps 604 and 605 are performed after the user group is determined in step 607, described next.

If there is no change on the client side portion of the context recognition model, then in step 607, the user group of the user who sent the message received in step 603 is determined and the context recognition model for that user group is applied to derive the context label from the context data provided by the user. The user group is determined as described in more detail below with reference to FIG. 6B. In some embodiments, the user group definitions evolve over time, as new data is accumulated, and the method described in FIG. 6B also handles the proper selection of user group under such circumstances. Thus, step 607 includes determining, based on the value of the attribute for the user, a particular group of user types to which the user belongs. For purposes of illustration, it is assumed that the user group is determined to be “Beijing.”

Step 607 includes determining the context label and confidence level for the user group. For example, the context data is compared to the statistical summary data in field 338 in each context item 330 of the user group entry record 310 until a match is found. The context label in field 332 in the context item 330 in which the match is found is the resulting label. The confidence level in the statistical summary data field 338, if any, determines the confidence level of the context label. For purposes of illustration, it is assumed that the context label is “restaurant” and the confidence level is “moderate” because there is wide disparity in the context data associated with the label “restaurant,” in the Beijing user group.

In step 609, it is determined to send the label and any confidence level to the client 127 on the UE 101. For example, a message indicating that context label=“restaurant” and confidence=“moderate” is sent from service 120 to client 127 on UE 101a. Thus, step 609 includes determining to send a context label based on the context data and the particular group. Because the confidence is not high, the client 127 will present the context label “restaurant” with an alert, such as an audio beep. In some embodiments, the confidence level is determined, at least in part, based on the number of contributors to the user group. Thus, step 609 includes determining to send a confidence measure based on a number of contributors to a data structure for the particular group.

In step 611, it is determined whether an adapt context message is received, such as adapt context message 360. If not, then control passes to step 631 to determine if end conditions are satisfied. If so, the process ends. Otherwise, control passes back to step 603 and following, described above.

If it is determined, in step 611, that an adapt context message 360 is received, then in step 613 the user group for the user is determined base on the user property. The user is a contributing user and the determination during step 613 is made as described in more detail below with reference to FIG. 6C. A contributing user can cause a user group to spawn two or more child user groups, as described with reference to FIG. 6C. A contributing user record 320 is added to the current user group, and to every user group from which the current user group descends

, with at least some of the data from the adapt context message 360 just received. Thus, step 611 includes receiving second data that indicates context measurements associated with the context data and a user-selected context label. As a contributing user field 320 is added to a user group entry field 310, the number of contributions indicated in field 314 is incremented.

For purposes of illustration, it is assumed that an adapt context message 350 is received from the client 127 on UE 101a in which the user property in field 354 is “Yizhuang, Beijing, central region, China, Asia,” and the label in field 362 indicates “museum,” and the context measurement data in field 364 includes the audio time series and the 3D acceleration time series for a recent ten second interval. For purposes of illustration, it is assumed that based on the user property, the current user group is determined to be a new child user group named “Yizhuang.” The new user group includes the data from all contributing users who are in the Beijing user group but who have a user property that includes “Yizhuang.” A new contributing user field 320 that includes user property “Yizhuang, Beijing, central region, China, Asia” in field 322, and “museum” in field 324 and the time series data in field 326 is added to the new group entry field 310 and is designated the current contributing user field 320. The same record is also added to the parent user group “Beijing” and its parent user group “central region” and its parent user group “China” and its parent user group “Asia.” An advantage of adding the context measurement data in association with the user property is that new child groups can be spawned with all the context measurements data for the new user group, so that a new context recognition model for the new group can be trained. The new model is reasonably expected to be more precise because it only attempts to model a more homogeneous user group. The contributing user field 320 is an example means of achieving this advantage.

In step 615, a current context item field 330 in the new Yizhuang user group is determined based on the user provided label, e.g. the label “museum” indicated in field 362. The context item field 330 that includes “museum” in the context label field 332 is the current context item field 330 in the current user group entry record 310. In some embodiments, a current context item field is determined for each of the parent user groups from which the new user group descends; thus, updating the training data for all those user groups.

In step 617, the context measurement data in field 364 of the adapt context message 360 is added to the adaptation data field 337 in the context data field 336 of the current context item field 330, either directly or as a pointer to the contributing user field 320 where the data is stored. Thus, step 617 includes determining to add the context measurements to a data structure for the particular group in association with the user-selected context label. Because the number of contributions in field 314 is also incremented, step 617 includes incrementing a number of contributors to the data structure for the particular group. Step 617 also includes determining to add the context measurements to the data structure for a particular child group determined to be the current user group.

As described above, in the illustrated embodiment, the plurality of groups comprises a hierarchy of child groups included within parent groups. Thus, in such embodiments, step 617 includes determining to add the context measurements to the data structure for a parent group of the particular group in association with the different context label.

In step 621, it is determined if there are sufficient changes in the adaptation data for a context label to re-train the context recognition model of the user group, at least for that context label. If so, then in step 623, the context model for the current user group is re-trained using the adaptation data to augment the laboratory training set and any previously used training set provided by previous contributing users. For example, the EM or SVM learning algorithm is employed to deduce the context labels from the new expanded training set. As a result, the model data, such as the statistical summary data in field 338, is updated. For example, the range of audio and 3D acceleration spectral amplitudes associated with labels “restaurant” and “museum” are updated. Thus, step 623 includes determining updated context data associated with the user-selected context label based at least in part on the context measurements.

During subsequent execution, step 605 includes determining to send the updated context data associated with the user-selected context label to at least one of the device of the user or a different device of a different user.

In the illustrated embodiment, when the number of contributing users increases above some factor of the minimum contribution threshold, a user group spawns two or more child user groups. However, the parent group is not replaced, but continues on. Thus a user who falls in a child group with insufficient data to train a model can rely on the model for the parent group, as described in more detail below with reference to FIG. 6B and FIG. 6C.

FIG. 6B is a flowchart of a step 607 of the process 600 of FIG. 6A, according to an embodiment. Method 650 is a particular embodiment of step 607. In step 651 the property of the user received in the get context message 350 is compared to the user properties similarity threshold data in field 316 of the nodes in the deepest level the user group hierarchy 203. If the user property is within the similarity threshold of one of those user groups, then that user group is a candidate user group. If no node is found at that level of the hierarchy for which the property of the user is within the similarity threshold, then the user group nodes in the next deepest level are examined. The process continues until a candidate user group is found for which the property of the user is within the similarity threshold. Thus, step 651 includes determining that a value of the attribute of the user is similar to a range of values for the attribute associated with the particular group.

In step 653, it is determined whether the number of contributions (e.g., in field 314) in the candidate group is less than a predetermined contribution threshold for the minimum number of contributions. If not, then there are a sufficient number of contributions to have trained a context recognition model and control passes to step 657 to determine that the candidate user group is the current user group.

If the number is less than the predetermined threshold for the minimum number of contributions, then, in step 655, the parent of the candidate user group becomes the candidate group. Control passes back to step 653 to see if the new candidate group has a sufficient number of contributions to have defined a context recognition model.

Method 650 is an example means to achieve the advantage of always having a context recognition model for a user even as child user groups with few contributing users are spawned from a parent user group with an excess of contributing users.

FIG. 6C is a flowchart of a different step 613 of the process 600 of FIG. 6A, according to an embodiment. Method 670 is a particular embodiment of step 613. In step 671

In step 671, it is determined whether the property of the user who sent the adapt context message is within the similarity threshold of an existing user group. As in step 651, the search is made in order form the deepest level of the user group hierarchy 203 to the highest level closest to the root user group. This step is an example means of achieving the advantage of finding the most homogeneous group in which the current user is a member. If the property of the current user is not within any existing user group, then, in step 681, a new user group is started as a child of the root user group or another user group with which the property of the current user is most similar. In step 683, the child group just started is determined to be the current user group, and the method ends. During step 683, a group entry field 310 is added to the group data structure 300. The new group entry field 310 includes a new group ID value in field 312 and a value of one (1) in the number of contributions field 314. The user properties similarity threshold field 316 indicates the current user property as the center of mass of the cluster and a similarity threshold no greater than the distance to the nearest existing user group. The parent group ID, such as the root user group, is indicated in field 318.

If it is determined in step 671 that the property of the user who sent the adapt context message is within the similarity threshold of a particular existing user group, then in step 673 the number of contributions in field 314 is incremented.

In step 675, it is determined if the incremented number of contributions exceeds a predetermined factor greater than one of the predetermined contribution threshold for a minimum number of contributions. For example, it is determined if the number of contributions exceeds two times the predetermined contribution threshold. If not, then control passes to step 677, where the current user group is determined to be the particular existing group; and the process ends. Thus, step 675 includes determining whether the incremented number of contributors exceeds a factor of a predetermined threshold for a minimum number of contributors to a group, wherein the factor is greater than one.

If it is determined, in step 675, that the incremented number of contributions exceeds the predetermined factor greater than one of the predetermined threshold, then in step 691 two or more child groups are spawned from the particular existing group. In some embodiments, step 691 includes determining two or more clusters of user property values for the particular group, based on the user property value in field 322 of the contributing user fields 320. A new child user group is defined for each cluster. The contributing user fields 320 are copied from the particular user group to the corresponding one of the child user groups. Thus the contributing user fields 320s of all the child user groups are still included in the particular user group that serves as parent to all the new child user groups. Therefore, step 691 includes copying data of the particular group into a plurality of child groups based on ranges of values of attributes of user, if the number of contributors exceeds the factor of the predetermined threshold.

It is noted that some child user groups may have fewer than the predetermined threshold of minimum number of contributions. Such child user groups will not have context recognition models trained, until the number of contributing users reaches that predetermined threshold. Any user whose property falls within the similarity threshold of such a child user group will rely on the context recognition model of the parent user group, as described above with respect to FIG. 6B.

In step 693 the current user group is determined to be the child group with which the property of the current user is most similar. The similarity threshold in field 316 for the current user group is updated to account for the addition of the current user. Then the process ends. Thus, step 693 includes determining, based on the value of the attribute for the user, a particular child group to which the user belongs of the plurality of child groups.

As described above, when the system 100 collects enough adaptation data from the focused user group, the system 100 re-trains the context recognition model for the user group by using the adaptation data as training set. After the context recognition model has been re-trained, the updated parameters of the model are sent to the clients of the users in the user group, e.g., in step 605. Consequently, the context recognition components in each client are updated by taking advantage of the experience of other users. For example, even though a first user has never told her mobile device she is in a hot pot restaurant, the mobile device magically displays the hot-pot restaurant context label by analyzing the background sound. It is because other users have contributed their context measurements and label when they were in hot pot restaurants through their mobile devices.

In some embodiments, the user groups are built from the child up, rather than from the root down. For example, the users of the system are first grouped and organized at the finest scale of the hierarchy. The minimum of users in a user group is a predefined contribution threshold, e.g., 1000 contributing users. The users are grouped with as high threshold as possible while the minimum requirement of the size of a user group is satisfied. For example, if a one-dimensional location attribute is used, contributing users are first grouped by map application point of interest (POI). If some user groups are too small, they are re-grouped by district. If the user groups are still too small, they are re-grouped by city. The process is repeated iteratively until a largest group size is reached, such as country. Data can be smoothed and interpolated to handle the data scarcity. If a user group is already large enough, it is maintained while letting its contributing users also participate in the next round of grouping for dealing with the user groups that are too small. The users in this group can have one specific model. A larger area user group that includes the users from the small user groups has another more generic model.

For example, it is assumed for purposes of illustration that the system has 2,000 contributing users in Pudong district of Shanghai and only has 500 users and 700 users in Xuhui district and Yangpu district, respectively. In this case, the system groups all users by the city level similarity and all users in Shanghai are grouped into one user group “Shanghai”. However, the user group of “Pudong” is also maintained. The users from Pudong use the model for the “Pudong” user group and the users from other districts of Shanghai use the model for the “Shanghai” parent user group.

In some embodiments, the location of a mobile user is not precisely known, for example a GPS receiver is not installed, or the GPS satellites are not visible or the GPS system is otherwise not functioning. Thus the user's location context is poorly known. In some of these embodiments, the location context information is improved by associating a user with a group of other users for which group movement can be determined. For example, by analyzing the traffic variance among cellular base stations, it is found that the disorder (entropy) of group movement is less than the sum of the entropy of movements of individuals in the group. It is concluded that the trajectory of group movement is somehow steady compared to individual movements. This means that group movement is a ubiquitous property of human movement, e.g., is a universal phenomenon. Applying this conclusion, a method to predict a user's location based on group movement is described next, thus enhancing the benefits to mobile users by providing location-based and improved context based services.

Because the mobility of human individual has regularity (e.g., to and from work, to and from friends homes, and to and from shops), the regularity of group movement was considered. That is, it was considered whether the regularity of individual movement is independent or correlated, or in other words, “Do humans tend to move independently or tend to move together as a group?” By analyzing the real traffic data set of base stations with which mobile terminals in the vicinity communicate, it was demonstrated that human-beings' movement is not independent and that, substantively universally, their group movement is less disordered. Based on this study, some embodiments include a method to predict a user's location from others who are often around him/her because people normally share the same or similar trajectories.

In the illustrated embodiments, based on the past phone call or communication history monitored by the base stations owned by network operators, the moving group to which a user belongs at an indicated moment is determined. It is further determined that the users belonging to the same group should share the same trajectory. In other words, they should move like “one” as far as possible. Then a group's location is determined based on the group members (e.g., based on the location of a majority of the group members at the indicated time or a direction and speed of movement of the majority of the group members over a particular time interval ending at the indicated time).

If an individual user's real location cannot be tracked (e.g., the user's device is temporarily out of contact with a base station), then that user's location at a given time should be the same as, or close to, the group location at that time. Similarly, movement of that individual should parallel movement by the group in the time interval leading up to the given time. While a user location is indicated by the coverage area of a communication cell of a base station in the illustrated embodiment, it is anticipated that in other embodiments, the user location is indicated by other means, such as a geographic region (block or acre or square kilometer) determined by a GPS system, a coverage area of a wireless access point, a vicinity of a point of interest (POI) of a mapping program determined by the wireless access point or words communicated by voice or text, or any other means. In general, each location, designated xi, is chosen from a set X of locations designated X=(xi, i=1, L) where L is the number of locations in the set X.

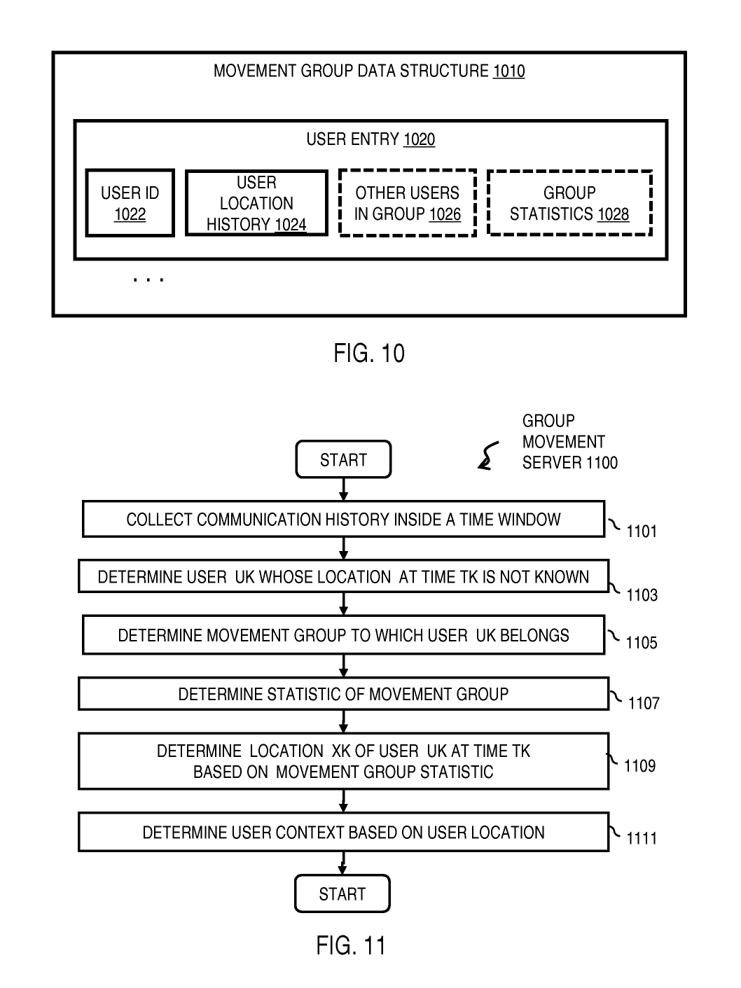

FIG. 10 is a diagram of a movement group data structure 1010, according to one embodiment. In the illustrated embodiment, the movement group data structure 1010 is maintained by a service of the network 105, e.g., by network service 110n, or by group context recognition service 120 in group context data store 124.

The movement group data structure 1010 includes a user entry field 1020 for every candidate user whose positions are being tracked, e.g., each cell phone in communication with each base station of a particular cellular telephone service provider, or each wireless data device in communication with each network access point of a particular network service provider. Other user entry fields are indicated by ellipsis for other users. In general, each user, designated ui, is chosen from a set U of candidate users designated U=(ui, i=1, M) where M is the number of candidate users in the set U.

Each user entry field 1020 includes a user identifier (ID) field 1022 and a user location history field 1024. In some embodiments, other users considered to be in the same movement group are indicated in other users in group field 1026 included within the user entry field 1020. In some embodiments, the movement statistics of the movement group are indicated in group statistics field 1028 included within the user entry field 1020.

The user ID field 1022 holds data that uniquely indicates a user ui by the user's particular mobile terminal, e.g., a particular cellular telephone or particular notebook computer. Such an identifier is always available for each device that communicates wirelessly with the network 105. For example, a telephone number is used to indicate a cellular telephone.

The user location history field 1024 holds data that indicates location of the user's device each time it is determined within a time window of interest. Any method may be used to determine time history. For example, the position xi is given each time the user's mobile terminal makes a connection (e.g., call or internet request), no matter how frequently or infrequently. For purposes of illustration, it is assumed that the locations are recorded whenever a call is made, and therefore the sample times designated ti are represented by the set T of times designated T=(ti, i=1, I) where I is the number of sample times. If a measurement of location is not available for the user at a particular time, then no data is included in the field 1024. A time window of interest, e.g., the most recent two hours, is represented by the start time ti and the stop time tj. For example, it three cell calls are made during that time interval, then field 1024 holds data that indicates (ta, xa), (tb, xb), (tc, xc). In some embodiments, to keep the size of field 1024 manageable, as observations fall outside of the time window of interest, those observations are dropped from the field 1024.

The other users in group field 1026 holds data that indicates a list of other users found to be in the user's movement group during the current time window, if any. In the illustrated embodiment, this list is determined on demand, as described in more detail with reference to FIG. 11, and is not recorded in the data structure 1010.

The group statistics field 1028 holds data that indicates the most probable location or direction of movement for users of the group at one or more times during the current time window, if any. In the illustrated embodiment, this information is determined on demand for a particular time tk, as described in more detail with reference to FIG. 11, and is not recorded in the data structure 1010.

FIG. 11 is a flowchart of a server process 1100 for determining user location based on the movement group, according to one embodiment. In one embodiment, the client group context recognition service 120 performs the process 1100 and is implemented in, for instance, a chip set including a processor and a memory as shown in FIG. 8 or a general purpose computer system as shown in FIG. 7.

In step 1101, communication history within a time window is collected, e.g., in user location history field 1024 of each user entry field 1020 for all the candidate users in set U.

In step 1103 a particular user uk is determined whose location xk is not known at a particular time tk. For example, a request is received from a service 110a to determine the location of the user uk at the current time tk, even though the user uk has not made a call for the past hour. If the user location xk at time tk is included in the user entry field 1024 for user uk, then the position is not unknown, and the control passes to step 1111, described below, to use the position xk for the context of user uk.

In step 1105 the movement group to which the particular user, uk, belongs is determined. The group is indicated by the list of users who are members of the group. Any method can be used to determine this. In the illustrated embodiment, this determination is made based on the observation that users who move in a group have a group entropy that is lower than the sum of the entropies of the individual members, as described in more detail below. The user belonging to a group should share the same trajectory. In other words, they should move like “one” person as far as possible. Movement entropy S, as given by dispersion D, is used as a measure to indicate how dispersed a group is. The dispersion D of N users in a group is given by Equation 1a.

D(N)=S(x)=−Σ_{i=1,L}p(xi)log₂ p(xi) (1a)

where p(xi) is the probability that one of the N users is in location xi, log₂ is the logarithm to the base 2. The probability p(xi) is given by Equation (1b)

p(xi)=Ni/N (1b)

where N is the number of users in the group and Ni is the number of users of the group in location xi. Obviously, if all users are in the same location, the D(N) is minimum and equal to 0; if no two users are located at the same place, D(N) is maximum and equal to log₂ N. Because the users' locations are time dependent, the sum of D(N) from time ti to time tj, designated sd(i,j) is given by Equation 2.

sd(i,j)=sum(D(N)i)=Σ_{i=ti,tj}D(N)i (2)

To determine the list of other users who belong in a movement group with the user uk, the following steps are taken during step 1105 in the illustrated embodiment. For each candidate user uj (j≠k) in U, the dispersion between uk and uj is computed using Equations 1a and 1b with N=2, for each time increment (e.g., 10 minutes) in the time window ti to tj. In some embodiments, the observations from the two records closest together in time are matched, provided they are within some maximum time separation from each other (e.g., 10 minutes). The multiple values of D(N) are then summed to determine sd(i,j) using Equation 2. If sd(i,j) is less than a threshold value, then uj is added to the movement group. In an illustrated embodiment, the threshold is set to 0.5 based on experiments. This threshold is chosen to limit the number of candidate users belonging to a single group. Note that the chosen members of the movement group may not know each other even though they appear to travel together, e.g., have the same subway ride to work every day.

In step 1107 a statistic of the movement group is determined. For example, the number of members of the group, designated Ng, and the current location of the group at time tk, designated Xg, are determined, e.g., as given by the location xi with the greatest probability value p(xi) in Equation 3, or the center of mass determined by a sum of the xi each weighted by its probability p(xi) in Equation 4.

Xg=argmax(p(xi)) at time tk (3)

Xg=Σ_{i=1,L}xi p(xi) at time tk (4)

where p(xi) is computed as given by Equation 1b for all, most or a sufficient number of positions xi in X A sufficient number is a number of positions xi such that the remaining probabilities should not equal the currently observed maximum.

In other embodiments, other statistics of the movement group are determined, such as the direction and rate of change of members of the group in time interval from ti to tk, where ti is the last time that the position of user uk was observed.

In step 1109, the location xk of user uk at time tk is determined based on the statistic of the movement group. A group member generally moves as a majority of members of the group does. This assumption has been verified by real user data collected for this embodiment, especially during day time. For example, the location xk is equal to Xg in some embodiments. In some embodiments, the location xk is given by the last observed location xi of user uk (at the time ti) and the rate of change and direction of the group in the interval ti to tk. In an illustrated embodiment, step 1109 includes setting xk to substantively equal Xg determined by Equation 3.

In step 1111, the current location xk of the user uk is used to determine the context of the user, or to deliver context aware services to the user, as described above. In some embodiments, step 1111 includes a service to share cost based on group movement. For example, User A requests, from a network service provider or operator (SP), cost sharing in a place at time t. Based on the movement group determination, the SP determines a number of other users who are probably nearby User A, e.g., probably in the same communication cell xk, including User B. Upon acknowledgement from User B, User A obtains a username or alias of User B from the SP. User A starts communicating (e.g., text chatting) with User B via local connectivity that costs less than communications through a different second base station.

In various embodiments, location determination provides one or more of the following advantages. Location determination is accurate withheld the location resolution. Stability of group movement has been verified with real mobile user data collected from 1300 base stations related to about 1,000,000 mobile users. Thus the accuracy of this method has been proved.

This location determination is efficient. Simple, low cost and automatic data collection is used. For example, in the illustrated embodiment the method is based on the communication data (phone call) automatically collected that record mobile users' normal routine communications to analyze and predict an individual users' location. The method is compatible with the existing mobile networking structure, thus easily implemented. The deployment cost is low because in many embodiments, no extra hardware or software is involved, except for a reporting mechanism located inside base stations. In some embodiments a location prediction mechanism or service is implemented on an SP host in order to support location based services.

Location determination is flexible enough to support various mobile services. For example, it can be used to find a person's location and thus provide useful context information (e.g. news can be pushed to a mobile device via local connectivity in the subway, thus avoid extra connection cost and achieve sound performance). It can be used to find a group of people near a place to try to organize some campaign based on their movement information. It can be used to initiate some location based social networking services. The user could be informed that a friend is actually in the same shopping mall. Additionally, the user could be informed that a person (or many persons) have been in the user's location for many days and contact should be considered for making a new friend or for sharing a ride to save a cost. Additionally, the user could be informed of others in the group from whom to inquire help or recommendations even though they are not otherwise known to each other. Such help is especially useful in an emergency, e.g., when the user is in some danger.

Some theoretical underpinnings are described here for purposes of a thorough description. However, the embodiments are not limited by the accuracy or completeness of the following description.

In information theory, entropy is a measure of the uncertainty associated with a random variable. The smaller the entropy of trajectory, the more steady the user's mobility is. Here is given a definition of movement entropy (hereinafter, simply “entropy”) to indicate movement stability. Let Xi be a random variable representing a user's location at time i. Movement entropy, designated S, is defined by Equation 5:

S(X)=−Σ_{xεX}p(x)log₂ p(x) (5)

where p(x)=P{Xi=x} is the probability that Xi=x. For a stationary stochastic process x={Xi} the movement entropy of a user can be written as given by Equation 6.

$$S ≡ {lim}_{n -> ∞} \frac{1}{n} S ( {X}_{1} , {X}_{2} , … , {X}_{n} ) \qquad ( 6 )$$

For a system containing N users, the system's entropy is given by Equation 7

$$S = \frac{1}{N} S ( {U}_{1} , {U}_{2} , … , {U}_{N} ) \qquad ( 7 )$$

where S(U₁, U₂, . . . , U_{N}) is the joint entropy of all users. Applying the properties of joint entropy that S(x,y)≦S(x)+S(y) gives Equation 8.

$$S ( {U}_{1} , {U}_{2} , … , {U}_{N} ) \leq {\sum }_{i}^{N} S ( {U}_{i} ) \qquad ( 8 )$$

where equality is achieved if and only if Ui is independent of Uj for i≠j. Because users' movements are observed not to be independent (some of them move together), in practice Equation 8 is strictly unequal. Combining Equations 7 and 8 give Equation 9.

$$S = \frac{1}{N} S ( {U}_{1} , {U}_{2} , … , {U}_{N} ) < \frac{1}{N} {\sum }_{i = 1}^{N} S ( {U}_{i} ) \qquad ( 9 )$$

Equation 9 indicates that the information used to describe a group's location is less than the sum of the group's users' locations; and, the group's movement entropy is less than the average entropy of users belonging to the group.

The lower bound of S(U₁, U₂, . . . , U_{N}) can be found using Equations 10a through 10c.

$$\begin{matrix}S ( Y \vert X ) ≡ {\sum }_{x ∈ X} p ( x ) S ( y \vert X = x ) & ( 10 a ) \\ = - {\sum }_{x ∈ X} p ( x ) {\sum }_{y ∈ Y} p ( y \vert x ) {log}_{2} p ( y \vert x ) & ( 10 b ) \\ = - {\sum }_{x ∈ X} {\sum }_{y ∈ Y} p ( x , y ) {log}_{2} p ( x , y ) & ( 10 c )\end{matrix}$$

The joint entropy S(x,y) can be written as S(x)+S(y|x). No entropy is less than zero; so, S(x,y)≧S(x). This yields Equation 11.

S(U₁, U₂, . . . , U_{N})≧S(Uᵢ)(1≦i≦N) (11)

Considering a group of users U₁, U₂, . . . , U_{N}, ideally they have the same trajectory and the conditional entropy of each given the other is equal to 0. Thus everyone's location is inferred from other users in the same group. Let S0 represent the movement entropy of user i, a group of users' movement can be described with |S0| bits instead of |NS0| bits (S(U₁, U₂, . . . , U_{N})=NS0). The lower bound indicates that a large amount of information can be saved due to the phenomenon of group movement.

Location determination preserves much privacy. The method is a kind of rough prediction. It is based on other people's movement history and a user's movement history to predict current location or future location. The method doesn't request the mobile users to disclose any more personal information than what they do today. The historical communication records can be preserved by the user's operator and its contracted service provider with the agreement of the users.

The processes described herein for collaborative context recognition may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) for collaborative context recognition as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of collaborative context recognition.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to collaborative context recognition. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for collaborative context recognition. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for collaborative context recognition, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for collaborative context recognition with the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed for collaborative context recognition as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of collaborative context recognition.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein for collaborative context recognition. The memory 805 also stores the data associated with or generated by the execution of the inventive steps.

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of collaborative context recognition. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of collaborative context recognition. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 for collaborative context recognition. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining a plurality of groups of user types, wherein each different group is associated with a corresponding different range of values for an attribute of a user;
receiving first data that indicates context data for a device and a value of the attribute for a user of the device;
determining, based on the value of the attribute for the user, a particular group of user types to which the user belongs; and
determining to send a context label based on the context data and the particular group.

2. A method of claim 1, wherein the attribute of a user comprises one or more of geographic location of the user, governmental province encompassing location of the user, age of the user, gender of the user, movement of the user, local industry in geographic location of the user, applications installed on device of the user, or semantic topics in messages exchanged with device of the user.

3. A method of claim 1, further comprising:
receiving second data that indicates context measurements associated with the context data and a user-selected context label; and
determining to add the context measurements to a data structure for the particular group in association with the user-selected context label.

4. A method of claim 3, wherein determining to add the context measurements to the data structure for the particular group in association with the different context label further comprises incrementing a number of contributors to the data structure for the particular group.

5. A method of claim 4, wherein determining to add the context measurements to the data structure for the particular group further comprises:
determining whether the incremented number of contributors exceeds a factor of a predetermined threshold for a minimum number of contributors to a group, wherein the factor is greater than one; and
if the number of contributors exceeds the factor of the predetermined threshold, then copying data of the particular group into a plurality of child groups based on ranges of values of attributes of users.

6. A method of claim 5, wherein determining to add the context measurements to the data structure for the particular group further comprises:
determining, based on the value of the attribute for the user, a particular child group to which the user belongs of the plurality of child groups; and
determining to add the context measurements to the data structure for the particular child group.

7. A method of claim 3, further comprising determining updated context data associated with the user-selected context label based at least in part on the context measurements.

8. A method of claim 7, further comprising determining to send the updated context data associated with the different context label to at least one of the device of the user or a different device of a different user.

9. A method of claim 3, wherein:
the plurality of groups comprises a hierarchy of child groups included within parent groups; and
determining to add the context measurements to the data structure for the particular group in association with the different context label further comprises determining to add the context measurements to the data structure for a parent group of the particular group in association with the different context label.

10. A method of claim 1, wherein determining the particular group of user types to which the user belongs further comprises determining that a value of the attribute of the user is similar to a range of values for the attribute associated with the particular group.

11. A method of claim 1, wherein:
the plurality of groups comprises a hierarchy of child groups included within parent groups; and
determining the particular group of user types to which the user belongs further comprises
determining that a value of the attribute of the user is similar to a range of values for the attribute associated with a candidate group of the plurality of groups;
determining that a number of contributors of data to the candidate group is less than a predetermined threshold for a minimum number of contributors to a group; and
determining that the particular group is a parent group of the candidate group.

12. A method of claim 1, wherein the context label indicates a social environment in a vicinity of the device.

13. A method of claim 1, wherein determining to send a context label based on the context data and the particular group further comprises determining to send a confidence measure based on a number of contributors to a data structure for the particular group.

14. A method comprising:
determining a value of an attribute for a user of a device;
determining context data for a device based on context measurements at the device;
determining to send first data that indicates the context data and the value of the attribute for the user of the device; and
receiving a context label based on the context data and the value of the attribute for the user of the device.

15. A method of claim 14, wherein the attribute of a user comprises one or more of geographic location of the user, governmental province encompassing location of the user, age of the user, gender of the user, movement of the user, local industry in geographic location of the user, applications installed on device of the user, or semantic topics in messages exchanged with device of the user.

16. A method of claim 14, further comprising:
determining a user-selected context label based on input from a user of the device; and
determining to send second data that indicates the context measurements and the user-selected context label.

17. A method of claim 14, further comprising determining to present, on a display of the device, data that indicates one of the context label or the user-selected context label.

18. A method of claim 14, wherein a context label indicates a social environment in a vicinity of a device.

19. A method of claim 14, wherein:
receiving a context label further comprises receiving a confidence measure associated with the context label; and
the method further comprises presenting an alert if the confidence measure is below a confidence threshold.

20. An apparatus comprising:
at least one processor; and
at least one memory including computer program code for one or more programs,
the at least one memory and the computer program code configured to, with the at least one processor, cause the apparatus to:
determine a plurality of groups of user types, wherein each different group is associated with a corresponding different range of values for an attribute of a user;
receive first data that indicates context data for a device and a value of the attribute for a user of the device;
determine, based on the value of the attribute for the user, a particular group of user types to which the user belongs; and
determine to send a context label based on the context data and the particular group.

21. An apparatus of claim 20, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

22-25. (canceled)

26. A method comprising:
determining movement of a plurality of users during a first time interval;
determining a first user of the plurality of users and a first time within the first time interval;
determining a group of users with a similar movement to the first user during the first time interval; and
determining a location statistic for the group of users.

27. A method of claim 26, further comprising determining a location of the first user at the first time based on the location statistic.

28. A method of claim 26, wherein the location statistic is a most probable location among the group at the first time.

29. An apparatus comprising:
at least one processor; and
at least one memory including computer program code for one or more programs,
the at least one memory and the computer program code configured to, with the at least one processor, cause the apparatus to
determine movement of a plurality of users during a first time interval;
determine a first user of the plurality of users and a first time within the first time interval;
determine a group of users with a similar movement to the first user during the first time interval; and
determine a location statistic for the group of users.

30. An apparatus of claim 29, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

31-34. (canceled)
